(19) United States
(12) Patent Application Publication
(10) Pub. No.: US 2026/0138688 A1
(43) Pub. Date: May 21, 2026

(54) VEHICLE HAVING AN ACTIVE DIFFUSER

(71) Applicant: FCA US LLC, Auburn Hills, MI (US)

(72) Inventors: Mark J Skynar, Auburn Hills, MI (US); Fabian Heinz Dieter Krissel, Rüsselsheim (DE); Maxwell R Taylor, Auburn Hills, MI (US); Jonathan M Francis, Auburn Hills, MI (US); Samarasingham Jeyasingham, Auburn Hills, MI (US); Santiago Antonelli, Auburn Hills, MI (US)

(21) Appl. No.: 18/954,592

(22) Filed: Nov. 21, 2024

(51) Int. Cl. B62D 35/00; G06V 20/56

(52) U.S. Cl. CPC B62D 35/005; B62D 35/007; G06V 20/588

(57) ABSTRACT

A vehicle including a diffuser assembly that is movable between a non-deployed position and a deployed position, a deployment system configured to move the diffuser assembly between the non-deployed position and the deployed position, a controller configured to instruct the deployment system to move the diffuser assembly between the non-deployed and deployed positions, at least one device in communication with the controller that is configured to communicate signals to controller that are analyzed by the controller to determine whether the vehicle is travelling in an on-road environment or an off-road environment, wherein if the controller determines that the vehicle is travelling in an off-road environment, controller is configured to instruct the deployment system to either move the diffuser assembly from the deployed position to the non-deployed position or prevent the deployment system from moving the diffuser assembly from the non-deployed position to the deployed position.

### FIELD

The present disclosure relates to a vehicle having an active diffuser for improving aerodynamic characteristics of the vehicle.

### BACKGROUND

This section provides background information related to the present disclosure which is not necessarily prior art.

Diffusers improve the aerodynamic characteristics of a vehicle when the vehicle is, for example, operating at relatively greater velocities (e.g., 30 mph and greater). If a diffuser is deployed when the vehicle is travelling off-road, however, there is a risk that the diffuser may be contacted by an obstruction that can damage the diffuser. Thus, it would not be uncommon for an operator of the vehicle to be required to physically remove any panels associated with the diffuser from the vehicle before travelling off-road.

In addition, even if the vehicle is equipped with an active diffuser that can automatically transition between deployed and non-deployed positions based on various driving conditions (e.g., velocity), the design of such a diffuser is typically directed to either travelling on-road or travelling off-road. Put another way, if the diffuser is designed for a vehicle that can travel off-road, the length of the diffuser, the angle at which the diffuser is deployed, and other features can be tailored to provide satisfactory clearance between the diffuser and any potential obstacle that the vehicle may encounter while travelling off-road. While this can potentially reduce the risk of damage to the diffuser when travelling off-road, the fact remains that when the diffuser is designed to avoid contact with off-road obstacles, the diffuser does not have a design that optimizes the aerodynamic characteristics of the vehicle when the vehicle is travelling on-road at elevated velocities (e.g., 30 mph and greater).

Accordingly, there is a need for an active diffuser system that can maximize the aerodynamic characteristics of a vehicle while travelling on-road at increased velocities, while being able to avoid damage to the active diffuser system when the vehicle is travelling off-road.

### SUMMARY

This section provides a general summary of the disclosure, and is not a comprehensive disclosure of its full scope or all of its features.

According to a first aspect of the present disclosure, there is provided a vehicle that may include a vehicle body having a front end and a rear end; a diffuser assembly attached to at least one of the front end and rear end that is movable between a non-deployed position and a deployed position; a deployment system configured to move the diffuser assembly between the non-deployed position and the deployed position; a controller configured to instruct the deployment system to move the diffuser assembly between the non-deployed and deployed positions; and at least one device in communication with the controller that is configured to communicate signals to controller that are analyzed by the controller to determine whether the vehicle is travelling in an on-road environment or an off-road environment, wherein if the controller determines that the vehicle is travelling in an off-road environment, controller is configured to instruct the deployment system to either move the diffuser assembly from the deployed position to the non-deployed position or prevent the deployment system from moving the diffuser assembly from the non-deployed position to the deployed position.

According to the first aspect, the at least one device includes a camera positioned at at least one of the front end and the rear end of the vehicle body, the camera being configured to communicate images to the controller and the controller is configured to analyze the images to determine whether the vehicle is travelling in the on-road environment or the off-road environment.

According to the first aspect, the at least one device includes a switch that can be manually actuated between an on-road mode and an off-road mode, and upon actuation of the switch to the off-road mode the controller is configured to instruct the deployment system to either move the diffuser assembly from the deployed position to the non-deployed position or prevent the deployment system from moving the diffuser assembly from the non-deployed position to the deployed position.

According to the first aspect, the at least device includes a sensor that is configured to communicate a signal to controller that is indicative of the vehicle is operating in four-wheel drive mode, and upon receipt of the signal that is indicative of operating in the four-wheel drive mode, the controller is configured to instruct the deployment system to either move the diffuser assembly from the deployed position to the non-deployed position or prevent the deployment system from moving the diffuser assembly from the non-deployed position to the deployed position.

According to the first aspect, the diffuser assembly includes a primary panel, and a secondary panel and a skirt connected to the primary panel.

According to the first aspect, the primary panel is flush with the body of the vehicle and each of the secondary panel and the skirt are hidden from view in the non-deployed position.

According to the first aspect, the deployment system, based on an instruction received from the controller, is configured actuate the primary panel to the deployed position, which causes the skirt to be exposed.

According to the first aspect, the deployment system, based on an instruction received from the controller, is configured to actuate the secondary panel outward from the primary panel in the deployed position.

According to the first aspect, the deployment system includes a first actuator device and a second actuator device that are connected to the primary panel, and includes a third actuator device that is connected to the secondary panel.

According to a second aspect of the present disclosure, there is provided a method of operating a diffuser assembly of a vehicle that is movable between a non-deployed position and a deployed position by a deployment system that is in communication with a controller. The method may include using at least one device in communication with the controller that is configured to communicate signals to controller that are analyzed by the controller to determine whether the vehicle is travelling in an on-road environment or an off-road environment, wherein if the controller determines that the vehicle is travelling in an off-road environment, the controller is configured to instruct the deployment system to either move the diffuser assembly from the deployed position to the non-deployed position or prevent the deployment system from moving the diffuser assembly from the non-deployed position to the deployed position.

According to the second aspect, the at least one device includes a camera positioned at at least one of the front end and the rear end of the vehicle body, the camera being configured to communicate images to the controller and the controller is configured to analyze the images to determine whether the vehicle is travelling in the on-road environment or the off-road environment.

According to the second aspect, the at least one device includes a switch that can be manually actuated between an on-road mode and an off-road mode, and upon actuation of the switch to the off-road mode the controller is configured to instruct the deployment system to either move the diffuser assembly from the deployed position to the non-deployed position or prevent the deployment system from moving the diffuser assembly from the non-deployed position to the deployed position.

According to the second aspect, the at least device includes a sensor that is configured to communicate a signal to controller that is indicative of the vehicle is operating in four-wheel drive mode, and upon receipt of the signal that is indicative of operating in the four-wheel drive mode, the controller is configured to instruct the deployment system to either move the diffuser assembly from the deployed position to the non-deployed position or prevent the deployment system from moving the diffuser assembly from the non-deployed position to the deployed position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle that may have at least one active diffuser system according to a principle of the present disclosure;

FIG. 2 is a schematic representation of the vehicle illustrated in FIG. 1;

FIG. 3A is partial rear perspective view of a rear end of the vehicle illustrated in FIG. 1 having an active diffuser system in a non-deployed position;

FIG. 3B is a partial side perspective view of the rear end of the vehicle illustrated in FIG. 1 having the active diffuser system in the non-deployed position;

FIG. 3C is partial rear perspective view of the rear end of the vehicle illustrated in FIG. 1 having the active diffuser system in a deployed position;

FIG. 3D is a partial side perspective view of the rear end of the vehicle illustrated in FIG. 1 having the active diffuser system in the deployed position;

FIG. 4 is a side perspective view of the active diffuser system according to a principle of the present disclosure in the non-deployed (shown in phantom) and deployed positions; and

FIG. 5 is an isometric perspective view of the active diffuser system shown in FIG. 4; and

FIG. 6 is a flow chart depicting a method of deploying and preventing deployment of the active diffuser system according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

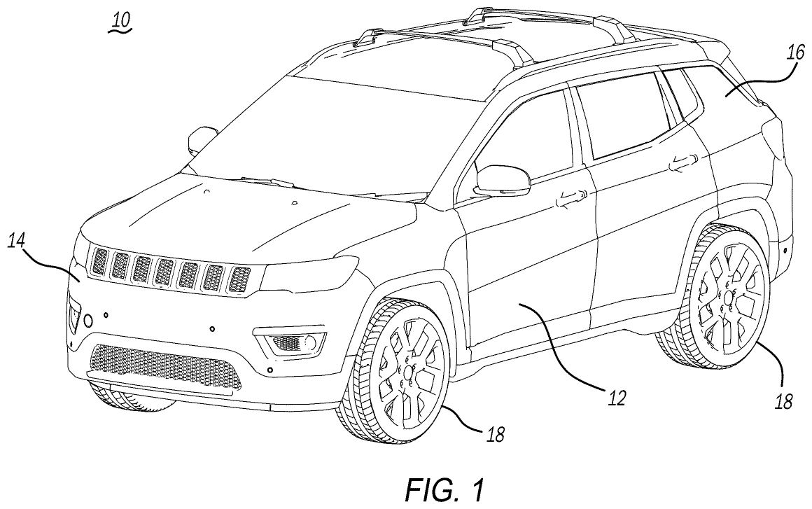

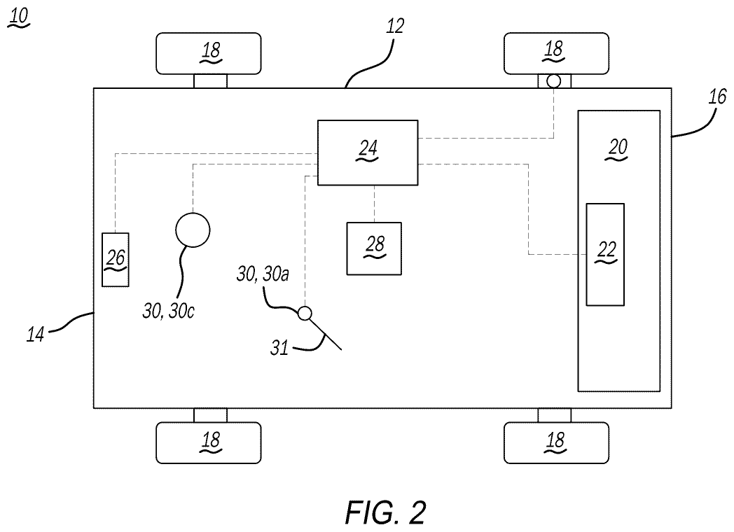

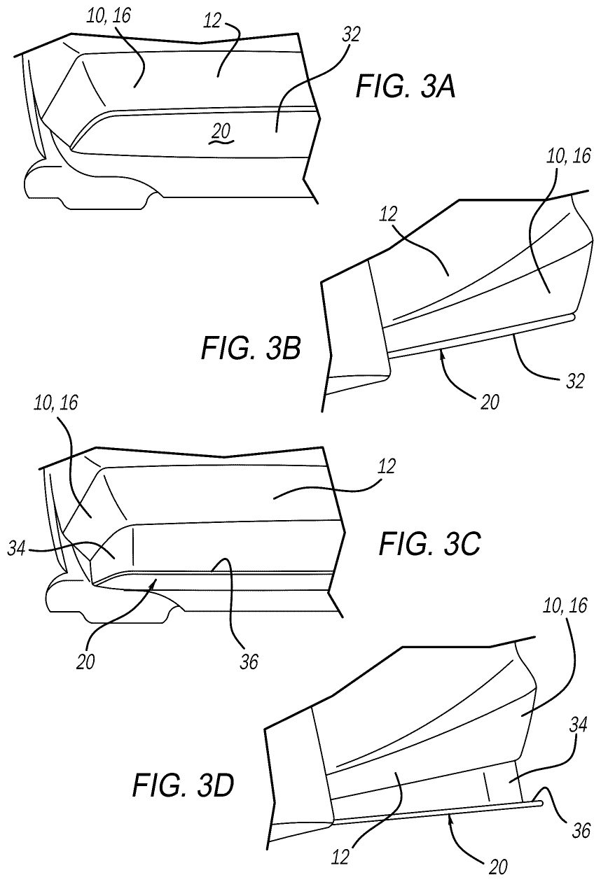

FIG. 1 illustrates an example vehicle 10 according to a principle of the present disclosure. Vehicle 10 includes a body 12 having a front end 14 and a rear end 16, and a plurality of wheels 18 that are driven by a propulsion system (not shown) that may be an internal combustion engine (ICE) system, a battery-powered electric drivetrain system, or a hybrid system that includes each of the ICE system and battery-powered electric drivetrain system. As best shown in FIGS. 2-3D, vehicle 10 may include a diffuser 20 that can be actuated by a deployment system 22 (e.g., motor) between a plurality of deployed positions and a non-deployed position. While diffuser 20 is illustrated as being located at the rear end 16 of vehicle 10, it should be understood that diffuser 20 can be positioned at front end 14 of vehicle 10, or vehicle 10 may include a diffuser 20 at each of the front end 14 and the rear end 16, without departing from the scope of the present disclosure. Still referring to FIG. 2, vehicle 10 also includes a controller 24 that communicates with deployment system 22, a camera 26 that may be positioned at front end 14 of vehicle 10, and a switch 28 located in a passenger cabin (not shown) of vehicle 10 that can transition the vehicle 10 between an on-road mode and an off-road mode. While camera 26 is illustrated at front end 14 of vehicle 10, it should be noted that another camera (not shown) may be located at rear end 16 of vehicle 10 as is common in the art that also communicates with controller 24.

Camera 26 can communicate images to controller 24, and based on the images transmitted by camera 26, controller 24 can determine the environment in which vehicle 10 is operating. That is, based on the images generated by camera 26 and communicated to controller 24, controller 24 can determine whether vehicle 10 is operating on-road or off-road. After determining whether vehicle 10 is operating on-road or off-road, controller 24 can communicate with deployment system 22 to either deploy diffuser 20 to one of its plurality of deployed positions, move diffuser 20 from one of its deployed positions to a non-deployed position, or prevent deployment system 22 from deploying diffuser 20 to one of its deployed positions.

Similarly, when an occupant actuates switch 28 to transition between an on-road mode and an off-road mode, or vice versa, controller 24 can determine the environment in which vehicle 10 is operating. That is, based on the position of switch 28, controller 24 can determine whether vehicle 10 is operating on-road or off-road. After determining whether vehicle 10 is operating on-road or off-road, controller 24 can communicate with deployment system 22 to either deploy diffuser 20 to one of its plurality of deployed positions, move diffuser 20 from one of its deployed positions to a non-deployed position, or prevent deployment system 22 from deploying diffuser 20 to one of its deployed positions.

It should also be understood that even if switch 28 is moved to the “off-road” position, controller 24 may still be able to determine that vehicle 10 is operating “on-road” based on the images communicated by camera 26 to controller 24. If, based on the images communicated by camera 26 to controller 24, controller 24 determines that vehicle 10 is operating “on-road” even though switch 28 indicates that vehicle 10 is operating “off-road,” controller 24 can override switch 28 and permit deployment of diffuser 20.

In general, deployment of diffuser 20 to one of its deployed positions is prevented if vehicle 10 is operating off-road to avoid damage to diffuser 20 while operating off-road. On the other hand, if vehicle 10 is operating on-road, which may include gravel roads and the like, controller 24 can communicate with deployment system 22 to deploy diffuser 20 to one of its deployed positions provided that other conditions (e.g., vehicle velocity) are met. These other conditions can be determined by controller 24 based on signals generated by at least one sensor 30 that are communicated to controller 24. For example, a sensor 30a can be used to determine a velocity of vehicle 10 by generating a signal indicative of a throttle position of a gas pedal 31 and/or a sensor 30b attached to one of the wheels 18 can be used to generate a signal indicative of how quickly wheels 18 are rotating (e.g., encoder sensor) to determine whether vehicle 10 is travelling at velocity that would benefit from deployment of diffuser 20. Another option that can be used to deploy or prevent deployment of diffuser 20 can be a sensor 30c or module that is attached to or part of a vehicle transmission (not shown) that can communicate a signal to controller 24 whether vehicle 10 is operating in four-wheel drive mode (if vehicle 10 is capable of operating in four-wheel drive). If vehicle 10 is in a four-wheel drive mode, deployment of diffuser 20 may not be ideal and, thus, prevented. Other sensors 30 known to one skilled in the art can also be used, without limitation.

Now referring to FIGS. 3A to 3D, an example active diffuser system 20 that is positioned at rear end 16 of vehicle 10 is illustrated. In FIGS. 3A and 3B, the diffuser 20 is in a non-deployed position. FIGS. 3C and 3D, in contrast, illustrate diffuser 20 in a fully deployed position. Diffuser 20 includes a primary bottom panel 32, a skirt 34 attached to primary bottom panel 32, and a secondary bottom panel 36 that can deploy outward from the primary bottom panel 32.

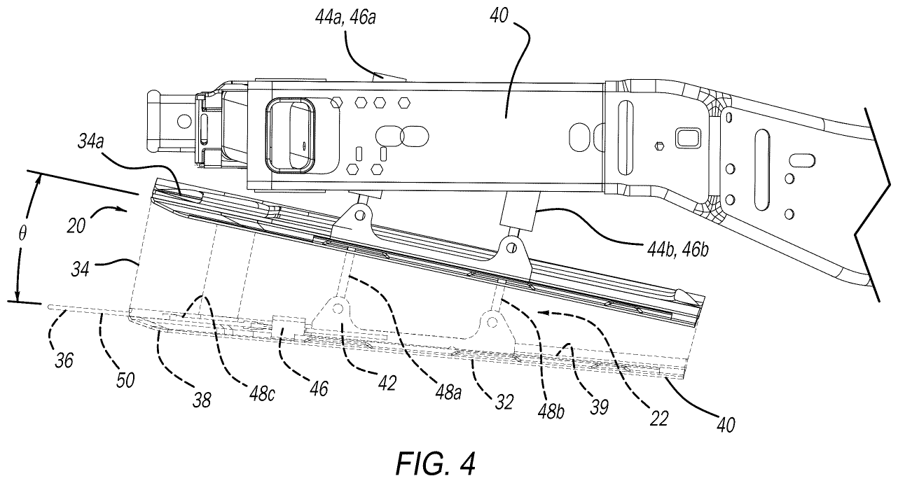

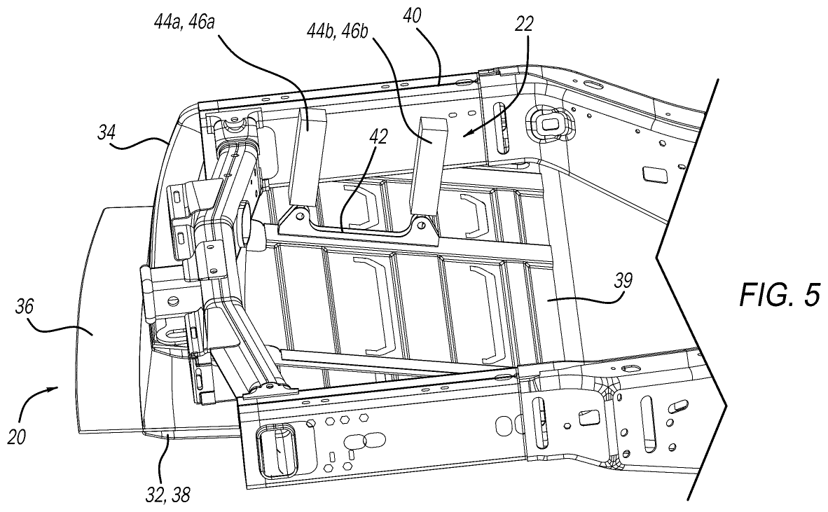

In FIGS. 3A and 3C, it can be seen that when diffuser 20 is in the non-deployed position, primary bottom panel 32 is “flush” with the body 12 at rear end 16. Inasmuch as primary bottom panel 32 forms at least a portion of the exterior of body 12 when non-deployed, primary bottom panel 32 may be formed of a rigid material such as aluminum, steel, or a rigid polymeric material. Primary bottom panel 32 includes a first end 38 that pivots relative to a frame 40 (FIG. 4) of vehicle 10 via deployment system 22, and an opposite second end 40. Skirt 34 is attached to primary bottom panel 32 at first end 38 via a third panel 39 that is best shown in FIG. 5.

Skirt 34 is hidden from view when diffuser 20 is in the non-deployed position. That is, skirt 34 may be formed from a flexible material such as a semi-rigid water-resistant cloth material that is configured to fold as shown at 34a in FIG. 4 when diffuser 20 is in the non-deployed position. When diffuser 20 is moved to the deployed position shown in FIG. 4, skirt 34 unfolds and creates a more aerodynamic surface that reduces drag of vehicle 10 to improve fuel and/or battery consumption. Example water-resistant cloth materials include polymeric (e.g., NYLON®) meshes and the like.

Primary bottom panel 32 can pivot relative to frame 40 through an angle Θ that can range between 3 degrees to 15 degrees. FIGS. 3C, 3D, and 4 illustrate the primary bottom panel 32 at the maximum angle of deployment. Further, while FIGS. 3C, 3D, and 4 illustrate secondary bottom panel 36 as being extended outward from primary bottom panel 32, it should be understood that secondary bottom panel 36 is not necessarily deployed only when primary bottom panel 32 is at the maximum angle of deployment.

Deployment system 22 includes a bracket 42 that may be attached to third panel 39. Bracket 42 is coupled to first and second actuator devices 44a and 44b that are fixed to frame 40 and include a housing 46a and 46b that includes a motor (not shown) that can actuate an arm 48a and 48b into and out of housings 46 a, 46 b. Arm 44 a has a greater length in comparison to arm 44b so that first end 38 can move through the angle Θ. As noted above, deployment system 22 is in communication with controller 24. Thus, controller 24 can control operation of the motors (not shown) provided in each housing 46a, 46b.

Deployment system 22 may also include a third actuator device 44c that includes a housing 46c including a motor (not shown) that can be used to deploy secondary panel 36. As shown in FIG. 4, housing 46c is attached to third panel 39 and includes an arm 48c that is connected to an aft end 50 of secondary panel 36. Upon actuation of the motor (not shown) provided in housing 46c, secondary panel 36 can be extended and retracted, as needed.

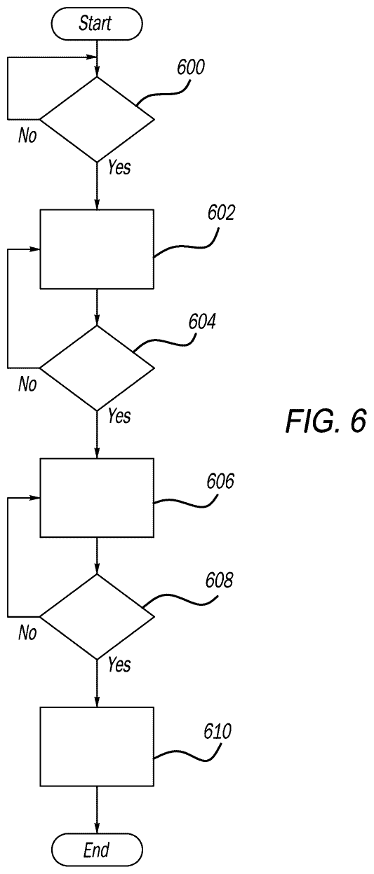

Now referring to FIG. 6, a method of operating diffuser 20 will be described. In FIG. 6, it should be assumed that vehicle 10 has been operating in an “on-road” mode at a velocity (e.g., 30 mph) where diffuser 20 has been deployed to improve the aerodynamic characteristics of vehicle 10. Firstly, in step 600 it is determined by controller 24 whether vehicle 10 has transitioned from operating “on-road” to “off-road.” This is accomplished by receiving images from camera 26 and analyzing the images to determine whether vehicle 10 is operating in an off-road environment or an on-road environment. Alternatively, controller 24 communicates with switch 28 to determine whether vehicle 10 has been manually transitioned from operating “on-road” to “off-road,” or receives communications from sensor 30c that indicates that vehicle 10 has transitioned to operating in a four-wheel drive mode. If any of these conditions are met, controller 24 may send an instruction to deployment system 22 to move diffuser 20 from the deployed position (see, e.g., FIGS. 3C and 3D) to the non-deployed position (see, e.g., FIGS. 3A and 3B) (step 602). In this manner, diffuser 20 is prevented from being damaged by any obstruction vehicle 10 may encounter why travelling off-road.

Next, in step 604, it is determined whether vehicle 10 is still travelling off-road. This is accomplished by receiving images from camera 26 and analyzing the images to determine whether vehicle 10 is still operating in an off-road environment or has transitioned to an on-road environment. Alternatively, controller 24 communicates with switch 28 to determine whether vehicle 10 has been manually transitioned from operating “off-road” to “on-road,” or receives communications from sensor 30c that indicates that vehicle 10 has transitioned from operating in a four-wheel drive mode to a non-four-wheel drive mode. If any of these conditions are met, controller 24 may cease sending instruction to deployment system 22 to prevent movement of diffuser 20 from the non-deployed position (see, e.g., FIGS. 3A and 3B) to the deployed position (see, e.g., FIGS. 3C and 3D) (step 606).

Next, controller 24 can receive signals from at least one of sensors 30a and 30b to determine whether vehicle 10 is operating at a velocity that may require assistance in improving the aerodynamic characteristics of vehicle 10 (step 608). If sensors 30a and/or 30b communicate signals to controller 24 that indicate that vehicle 10 is travelling at a velocity (e.g., 30 mph) that may require assistance in improving the aerodynamic characteristics of vehicle 10, controller 24 can communicate with deployment system 22 to move diffuser from the non-deployed position to a deployed position (step 610).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a vehicle body having a front end and a rear end;
a diffuser assembly attached to at least one of the front end and rear end that is movable between a non-deployed position and a deployed position;
a deployment system configured to move the diffuser assembly between the non-deployed position and the deployed position;
a controller configured to instruct the deployment system to move the diffuser assembly between the non-deployed and deployed positions; and
at least one device in communication with the controller that is configured to communicate signals to controller that are analyzed by the controller to determine whether the vehicle is travelling in an on-road environment or an off-road environment,
wherein if the controller determines that the vehicle is travelling in an off-road environment, controller is configured to instruct the deployment system to either move the diffuser assembly from the deployed position to the non-deployed position or prevent the deployment system from moving the diffuser assembly from the non-deployed position to the deployed position.

2. The vehicle according to claim 1, wherein the at least one device includes a camera positioned at at least one of the front end and the rear end of the vehicle body, the camera being configured to communicate images to the controller and the controller is configured to analyze the images to determine whether the vehicle is travelling in the on-road environment or the off-road environment.

3. The vehicle according to claim 1, wherein the at least one device includes a switch that can be manually actuated between an on-road mode and an off-road mode, and upon actuation of the switch to the off-road mode the controller is configured to instruct the deployment system to either move the diffuser assembly from the deployed position to the non-deployed position or prevent the deployment system from moving the diffuser assembly from the non-deployed position to the deployed position.

4. The vehicle according to claim 1, wherein the at least device includes a sensor that is configured to communicate a signal to controller that is indicative of the vehicle is operating in four-wheel drive mode, and upon receipt of the signal that is indicative of operating in the four-wheel drive mode, the controller is configured to instruct the deployment system to either move the diffuser assembly from the deployed position to the non-deployed position or prevent the deployment system from moving the diffuser assembly from the non-deployed position to the deployed position.

5. The vehicle according to claim 1, wherein the diffuser assembly includes a primary panel, and a secondary panel and a skirt connected to the primary panel.

6. The vehicle according to claim 1, wherein the primary panel is flush with the body of the vehicle and each of the secondary panel and the skirt are hidden from view in the non-deployed position.

7. The vehicle according to claim 6, wherein the deployment system, based on an instruction received from the controller, is configured actuate the primary panel to the deployed position, which causes the skirt to be exposed.

8. The vehicle according to claim 7, wherein the deployment system, based on an instruction received from the controller, is configured to actuate the secondary panel outward from the primary panel in the deployed position.

9. The vehicle according to claim 8, wherein the deployment system includes a first actuator device and a second actuator device that are connected to the primary panel, and includes a third actuator device that is connected to the secondary panel.

10. A method of operating a diffuser assembly of a vehicle that is movable between a non-deployed position and a deployed position by a deployment system that is in communication with a controller, the method comprising using at least one device in communication with the controller that is configured to communicate signals to controller that are analyzed by the controller to determine whether the vehicle is travelling in an on-road environment or an off-road environment, wherein if the controller determines that the vehicle is travelling in an off-road environment, the controller is configured to instruct the deployment system to either move the diffuser assembly from the deployed position to the non-deployed position or prevent the deployment system from moving the diffuser assembly from the non-deployed position to the deployed position.

11. The method according to claim 10, wherein the at least one device includes a camera positioned at at least one of the front end and the rear end of the vehicle body, the camera being configured to communicate images to the controller and the controller is configured to analyze the images to determine whether the vehicle is travelling in the on-road environment or the off-road environment.

12. The method according to claim 10, wherein the at least one device includes a switch that can be manually actuated between an on-road mode and an off-road mode, and upon actuation of the switch to the off-road mode the controller is configured to instruct the deployment system to either move the diffuser assembly from the deployed position to the non-deployed position or prevent the deployment system from moving the diffuser assembly from the non-deployed position to the deployed position.

13. The method according to claim 10, wherein the at least device includes a sensor that is configured to communicate a signal to controller that is indicative of the vehicle is operating in four-wheel drive mode, and upon receipt of the signal that is indicative of operating in the four-wheel drive mode, the controller is configured to instruct the deployment system to either move the diffuser assembly from the deployed position to the non-deployed position or prevent the deployment system from moving the diffuser assembly from the non-deployed position to the deployed position.
